(19) United States
(12) Patent Application Publication
(10) Pub. No.: US 2023/0418903 A1
(43) Pub. Date: Dec. 28, 2023

(54) FEATURE AMOUNT SELECTION DEVICE, FEATURE AMOUNT SELECTION METHOD, AND PROGRAM

(71) Applicant: University of Tsukuba, Ibaraki (JP)

(72) Inventors: Tetsuya SAKURAI, Tsukuba-shi (JP); Yasunori FUTAMURA, Tsukuba-shi (JP); Momo MATSUDA, Tsukuba-shi (JP)

(21) Appl. No.: 18/252,819

(22) PCT Filed: Nov. 18, 2021
(86) PCT No.: PCT/JP2021/042372

§ 371 Date: May 12, 2023

(30) Foreign Application Priority Data
Nov. 18, 2020 (JP) 2020-191502

(51) Int. Cl. G06F 17/18

(52) U.S. Cl. CPC G06F 17/18

(57) ABSTRACT

A feature amount selection device includes a feature amount data acquisition unit that acquires feature amount data including a set of values of a plurality of feature amounts for a sample, for each of a plurality of the samples, a principal component analysis unit that performs, on the feature amount data, principal component analysis in a sample space that is a collection of the plurality of feature amounts of a set of values for each of the plurality of the samples of the feature amounts, and a feature amount selection unit that selects a feature amount from among the plurality of the feature amounts based on a result of the principal component analysis performed by the principal component analysis unit.

### TECHNICAL FIELD

The present invention relates to a feature amount selection device, a feature amount selection method, and a program.

The present application claims priority based on Japanese Patent Application No. 2020-191502 filed in Japan on Nov. 18, 2020, the contents of which are incorporated herein by reference.

### BACKGROUND ART

In recent years, with the development of measurement devices and sensors such as next-generation sequencers and mass spectrometers, a large amount of high-dimensional data has been obtained. Therefore, an effective data analysis technique for such a large amount of high-dimensional data is strongly required. With high-dimensional data, there are problems such as an increase in calculation amount and deterioration in prediction accuracy due to too many explanatory variables. Therefore, in the analysis of high-dimensional data, the feature amount used for the analysis is reduced by selecting some feature amounts. However, due to the reduction of the feature amount, since information of the original data may be lost and the analysis accuracy may be deteriorated, it has been difficult to significantly reduce the feature amount while maintaining the analysis accuracy.

As a known technique for selecting a feature amount, a filter method and a wrapper method are known (for example, Patent Document 1). The filter method is a method of calculating a statistical numerical value (for example, chi-square value, Fisher information, ANNOVA test, variance of variables, and the like) for each feature amount and performing ranking. In the filter method, there is a possibility of removing information obtained by fusing a plurality of feature amounts. In the wrapper method, a main feature amount is selected on the basis of the accuracy of machine learning for a large number of combinations of the use or non-use of each feature amount. However, in the wrapper method, the number of combinations increases and the calculation amount becomes enormous when the number of feature amounts is large, and therefore it has been difficult to apply the wrapper method to large-scale data.

### CITATION LIST

### Non-Patent Document

Non-Patent Document 1: Lei Yu, Huan Liu, Feature Selection for High-Dimensional Data: A Fast Correlation-Based Filter Solution, “Proceedings of the Twentieth International Conference on Machine Learning (ICML-2003)”, Aug. 21, 2003, p. 856-863
Non-Patent Document 2: Andrew Butler, Paul Hoffman, Peter Smibert, Efthymia Papalexi, Rahul Satij a, Integrating single-cell transcriptomic data across different conditions, technologies, and species, “Nature Biotechnology”, Nature America, Inc., Apr. 2, 2018, Vol. 36, No. 5, p. 411-420
Non-Patent Document 3: “IGSR: The International Genome Sample Resource”, [online], EMBL-EBI, [searched on Jul. 31, 2020], Internet <URL:http://www.1000genomes.org>
Non-Patent Document 4: Saori Sakaue, Jun Hirata, Masahiro Kanai, Ken Suzuki, Masato Akiyama, Chun Lai Too, Thurayya Arayssi, Mohammed Hammoudeh, Samar Al Emadi, Basel K. Masri, Hussein Halabi, Humeira Badsha, Imad W. Uthman, Richa Saxena, Leonid Padyukov, Makoto Hirata, Koichi Matsuda, Yoshinori Murakami, Yoichiro Kamatani, Yukinori Okada, Dimensionality reduction reveals fine-scale structure in the Japanese population with consequences for polygenic risk prediction, “NATURE COMMUNICATIONS”, Springer Nature Limited, Mar. 26, 2020, Vol. 11, No. 1569, p. 1-11
Non-Patent Document 5: “Gene Expression Omnibus”, [online], National Center for Biotechnology Information, [searched on Jul. 31, 2020], Internet <URL:https://www.ncbi.nlm.nih.gov/geo/>
Non-Patent Document 6: Tim Stuart, Andrew Butler, Paul Hoffman, Christoph Hafemeister, Efthymia Papalexi, William M. Mauck III, Yuhan Hao, Marlon Stoeckius, Peter Smibert, Rahul Satij a, Comprehensive Integration of Single-Cell Data, “Cell”, Elsevier Inc., Jun. 13, 2019, vol. 177, p. 1888-1902

### SUMMARY OF INVENTION

### Technical Problem

Analysis of high-dimensional feature amount data has a problem in that accuracy of machine learning is deteriorated due to a large number of explanatory variables. The analysis of high-dimensional feature amount data also has a problem of taking an enormous amount of time for analysis calculation because the calculation amount is large. Speeding up calculation without impairing analysis accuracy in analysis of high-dimensional feature amount data is required.

The present invention has been made in view of the above points, and provides a feature amount selection device, a feature amount selection method, and a program capable of speeding up calculation without impairing analysis accuracy in analysis of high-dimensional feature amount data.

### Solution to Problem

The present invention has been made to solve the above problems, and one aspect of the present invention is a feature amount selection device including a feature amount data acquisition unit that acquires feature amount data including a set of values of a plurality of feature amounts for a sample, for each of a plurality of the samples, a principal component analysis unit that performs, on the feature amount data, principal component analysis in a sample space that is a collection of the plurality of feature amounts of a set of values for each of the plurality of the samples of the feature amounts, and a feature amount selection unit that selects a feature amount from among the plurality of the feature amounts based on a result of the principal component analysis performed by the principal component analysis unit.

In one aspect of the present invention, the feature amount selection device described above further includes a distortion determination unit that determines whether there is distortion in the distribution of a principal component obtained by the principal component analysis in the sample space, in which the feature amount selection unit selects a feature amount from among the plurality of the feature amounts based on a principal component determined to have no distortion in the distribution among the principal components obtained by the principal component analysis.

In one aspect of the present invention, in the feature amount selection device, the feature amount selection unit selects a feature amount having a large distance from an origin of the sample space for a principal component determined to have no distortion in the distribution.

One aspect of the present invention is a feature amount selection method including feature amount data acquisition of acquiring feature amount data including a set of values of a plurality of feature amounts for a sample for each of a plurality of the samples, principal component analysis of performing, on the feature amount data, principal component analysis in a sample space that is a collection of the plurality of feature amounts of a set of values for each of the plurality of the samples of the feature amounts, and feature amount selection of selecting a feature amount from among the plurality of the feature amounts based on a result of the principal component analysis performed in the principal component analysis.

One aspect of the present invention is a program for causing a computer to execute feature amount data acquisition of acquiring feature amount data including a set of values of a plurality of feature amounts for a sample for each of a plurality of the samples, principal component analysis of performing, on the feature amount data, principal component analysis in a sample space that is a collection of the plurality of feature amounts of a set of values for each of the plurality of the samples of the feature amounts, and feature amount selection of selecting a feature amount from among the plurality of the feature amounts based on a result of the principal component analysis performed in the principal component analysis.

### Advantageous Effects of Invention

According to the present invention, it is possible to speed up calculation without impairing analysis accuracy in analysis of high-dimensional feature amount data.

### BRIEF DESCRIPTION OF DRAWINGS

FIG. 1 is a view illustrating an example of a configuration of a feature amount selection system according to an embodiment of the present invention.

FIG. 2 is a view showing a definition of a feature amount space according to the embodiment of the present invention.

FIG. 3 is a view showing a definition of a sample space according to the embodiment of the present invention.

FIG. 4 is a view illustrating an example of feature amount selection processing of a feature amount selection device according to the embodiment of the present invention.

FIG. 5 is a view illustrating an example of artificial data according to a first example of the present invention.

FIG. 6 is a view illustrating an example of a result of cluster analysis of a comparison target according to the first example of the present invention.

FIG. 7 is a view illustrating an example of a first principal component and a second principal component in a sample space according to the first example of the present invention.

FIG. 8 is a view illustrating an example of a third principal component and a fourth principal component in the sample space according to the first example of the present invention.

FIG. 9 is a view illustrating an example of a distribution of the first principal component in the sample space according to the first example of the present invention.

FIG. 10 is a view illustrating an example of a distribution of a sixth principal component in the sample space according to the first example of the present invention.

FIG. 11 is a view illustrating an example of a result of dimension reduction in a feature amount space according to the first example of the present invention.

FIG. 12 is a view illustrating an example of a result of cluster analysis of a comparison target according to a second example of the present invention.

FIG. 13 is a view illustrating an example of a first principal component and a second principal component in a sample space according to the second example of the present invention.

FIG. 14 is a view illustrating an example of a third principal component and a fourth principal component in the sample space according to the second example of the present invention.

FIG. 15 is a view illustrating an example of a distribution of the first principal component in the sample space according to the second example of the present invention.

FIG. 16 is a view illustrating an example of a distribution of the fourth principal component in the sample space according to the second example of the present invention.

FIG. 17 is a view illustrating an example of a result of dimension reduction in a feature amount space according to the second example of the present invention.

FIG. 18 is a view illustrating an example of a result of cluster analysis of a comparison target according to a third example of the present invention.

FIG. 19 is a view illustrating an example of a first principal component and a second principal component in a sample space according to the third example of the present invention.

FIG. 20 is a view illustrating an example of a third principal component and a fourth principal component in the sample space according to the third example of the present invention.

FIG. 21 is a view illustrating an example of a distribution of the first principal component in the sample space according to the third example of the present invention.

FIG. 22 is a view illustrating an example of a distribution of a fifth principal component in the sample space according to the third example of the present invention.

FIG. 23 is a view illustrating an example of a result of dimension reduction in a feature amount space according to the third example of the present invention.

### EMBODIMENT

### Description of Embodiments

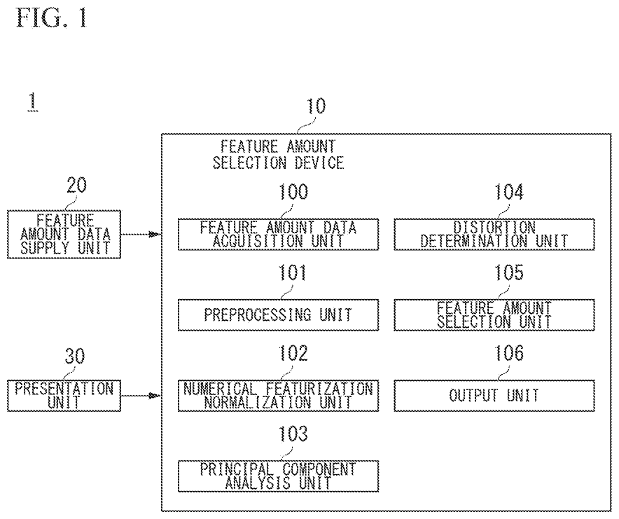

Embodiments of the present invention will be described below in detail with reference to the drawings. FIG. 1 is a view illustrating an example of the configuration of a feature amount selection system 1 according to the present embodiment. The feature amount selection system 1 performs, on high-dimensional feature amount data, principal component analysis in a sample space, and selects a feature amount on the basis of a sample space principal component that contributes to cluster separation of a sample. In known multivariate analysis, analysis such as principal component analysis is performed on a feature amount space. On the other hand, the feature amount selection system 1 captures a relationship among a plurality of feature amounts in a sample space.

The sample space is a collection of a plurality of feature amounts of a set of values for each of a plurality of samples of feature amounts. In the sample space, for example, in a space having a dimension corresponding to each of the plurality of samples, points corresponding to the plurality of feature amounts are plotted and visualized. Note that the feature amount space used for the known analysis is a collection of a plurality of samples of a set of values of a plurality of feature amounts for the samples.

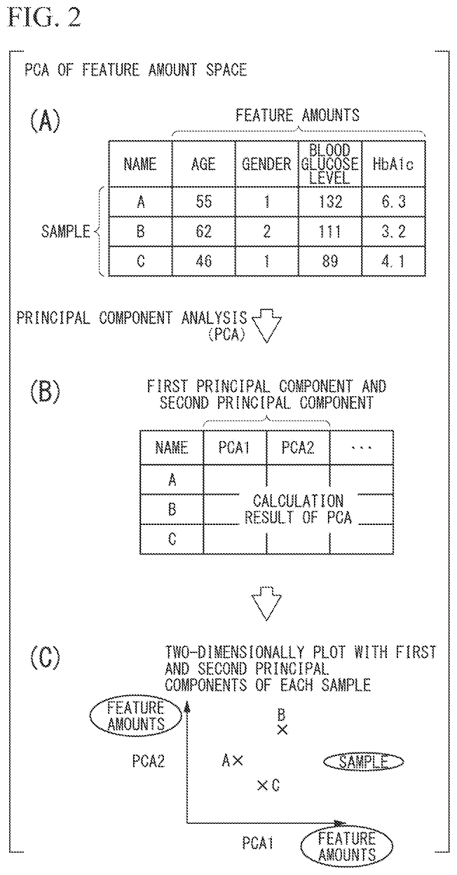

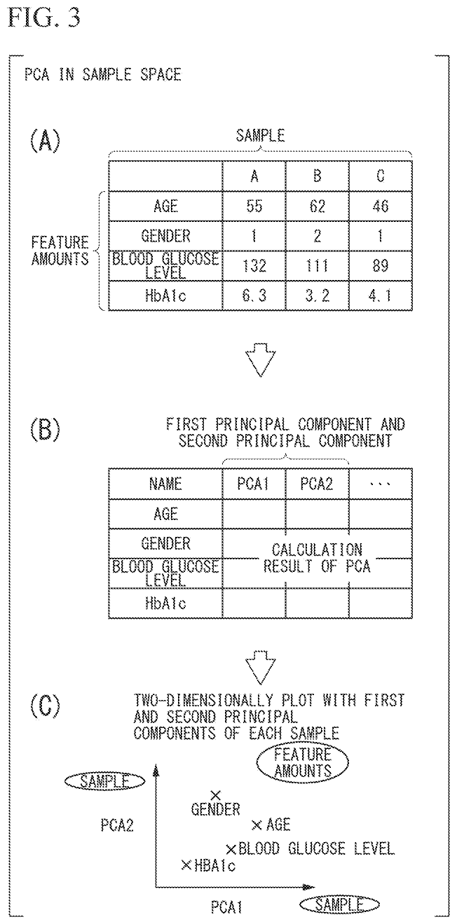

Here, the definition of each of the feature amount space and the sample space will be described with reference to FIGS. 2 and 3. In the description of FIGS. 2 and 3, m and n each represent a natural number.

In the present embodiment, the feature amount space is defined as follows. It is assumed that in data to be input (above-described high-dimensional feature amount data), n samples are included, and each sample is composed of m feature amounts. It is assumed that the data to be input is table-format data. In this case, the data to be input has a sample, and a column for each item of the m feature amounts. That is, the data to be input is table-format data including rows and columns in which the value of the feature amount is stored for each sample. Assuming that all the m feature amounts are numerical values, each sample can be regarded as a point on an m-dimensional space. In the m-dimensional space, m-dimensional coordinate axes correspond to respective m feature amounts. The m-dimensional space is called a feature amount space.

For example, in the table-format data illustrated in FIG. 2(A), each sample (as an example, an individual indicated by “name”) is composed of m feature amounts (as an example, four feature amounts of age, gender, blood glucose level, and “HbA1c”). As illustrated in FIG. 2(B), a principal component (as an example, the first principal component and the second principal component) is obtained from each feature amount by principal component analysis in the feature amount space. As illustrated in FIG. 2(C), when each sample is plotted with the first principal component and the second principal component as axes, a distance relationship among the samples is expressed in a two-dimensional space.

Next, in the present embodiment, the sample space is defined as follows. In the data to be input that is the above-described table-format data, rows and columns are interchanged, newly giving table-format data. The new table-format data includes a feature amount, and a column for each item of n samples. That is, the new table-format data is table-format data including rows and columns in which the value for a sample of the feature amount is stored for each feature amount. In this case, the number of samples is n, and each feature amount can be regarded as a point on an n-dimensional space. In the n-dimensional space, n-dimensional coordinate axes correspond to respective n samples. The n-dimensional space is called a sample space.

As an example, FIG. 3(A) illustrates a result of interchanging rows and columns of the table-format data illustrated in FIG. 2(A). As illustrated in FIG. 3(B), a principal component (as an example, the first principal component and the second principal component) is obtained from each sample by principal component analysis in the sample space. As illustrated in FIG. 3(C), when each feature amount is plotted with the first principal component and the second principal component as axes, a distance relationship among the feature amounts is expressed in a two-dimensional space. In the present embodiment, selection of feature amounts is performed on the basis of the distance relationship among the feature amounts on the sample space.

In FIG. 1, the description of the configuration of the feature amount selection system 1 will be continued.

Functional Configuration of Feature Amount Selection System 1

The feature amount selection system 1 includes a feature amount selection device 10, a feature amount data supply unit 20, and a presentation unit 30.

The feature amount data supply unit 20 supplies the feature amount selection device 10 with high-dimensional feature amount data. The high-dimensional feature amount data is data including a set of values of a plurality of feature amounts for a sample for each of a plurality of samples. Here, the dimension of a feature amount means the number of feature amounts. A high dimension means that the number of feature amounts is a predetermined number (for example, thousands) or more. In the following description, the high-dimensional feature amount data is simply referred to as feature amount data D. Note that the number of feature amounts included in the feature amount data D may be equal to or less than a predetermined number, and may be, for example, several to hundreds.

The feature amount data D is, for example, two-dimensional array type data including rows and columns in which values of a plurality of feature amounts are stored for each sample. In the array, for example, the row corresponds to the sample, and the column corresponds to the feature amount. Therefore, in the feature amount data D, for example, the cell of the i-th row and the j-th column stores the value of the j-th feature amount of the i-th sample. The feature amount may be either a feature amount expressed as a categorical variable or a feature amount expressed by a numerical value. Hereinafter, the feature amount expressed as a categorical variable is also called a categorical feature amount, and the feature amount expressed using a numerical value is also called a numerical feature amount.

The feature amount data supply unit 20 may be, for example, an information storage device such as a server, or a human interface device such as a keyboard, a tablet, or a scanner.

The feature amount selection device 10 includes a feature amount data acquisition unit 100, a preprocessing unit 101, a numerical featurization normalization unit 102, a principal component analysis unit 103, a distortion determination unit 104, a feature amount selection unit 105, and an output unit 106. The feature amount selection device 10 is, for example, a personal computer (PC). Each functional unit included in the feature amount selection device 10 is implemented by a central processing unit (CPU) reading a program from a read only memory (ROM) and executing processing.

The feature amount data acquisition unit 100 acquires the feature amount data D supplied by the feature amount data supply unit 20.

The preprocessing unit 101 performs preprocessing on the feature amount data D. A specific example of the preprocessing will be described later.

The numerical featurization normalization unit 102 performs processing of numerical featurization and normalization on the feature amount data D having been subjected to the preprocessing. A specific example of processing of numerical featurization and normalization will be described later.

The principal component analysis unit 103 performs principal component analysis in the sample space on the feature amount data D. The principal component obtained by principal component analysis in the sample space is referred to as a sample space principal component P. The sample space principal component P includes as many principal components as the number of dimensions of the sample space, and the principal components are referred to as a first principal component, a second principal component, and the like.

The distortion determination unit 104 determines whether there is distortion in the distribution of the sample space principal component P. A specific example of distortion in the distribution of the sample space principal component P will be described later.

The feature amount selection unit 105 selects a feature amount from among a plurality of feature amounts on the basis of a result of the principal component analysis performed by the principal component analysis unit 103. As an example, the feature amount selection unit 105 selects a feature amount from among a plurality of feature amounts on the basis of a principal component determined to have no distortion in the distribution in the sample space principal component P.

The output unit 106 outputs a feature amount selection result R to the presentation unit 30. The feature amount selection result R is information indicating the feature amount selected by the feature amount selection unit 105 among the feature amounts included in the feature amount data D.

The presentation unit 30 presents, by a presentation means such as display or printing, the feature amount selection result R output from the output unit 106 included in the feature amount selection device 10. The presentation unit 30 is, for example, a display or a printer.

Note that the presentation unit 30 may be a storage device such as a network server. In this case, the presentation unit 30 stores the feature amount selection result R output from the output unit 106, and supplies the stored feature amount selection result R to another device.

### Operation of Feature Amount Selection Device 10

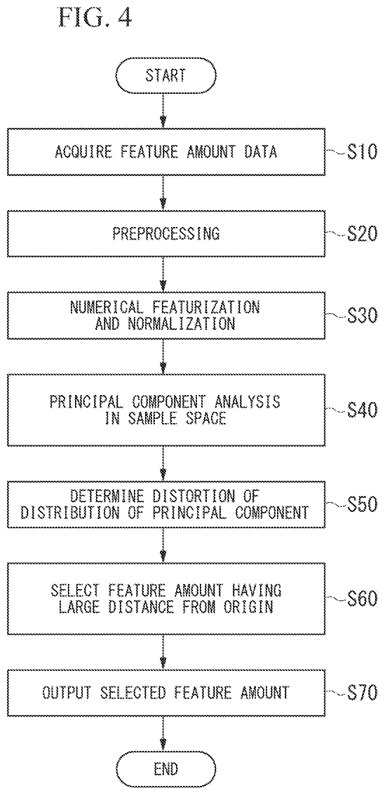

Next, feature amount selection processing, which is processing for the feature amount selection device 10 to select a feature amount, will be described with reference to FIG. 4. FIG. 4 is a view illustrating an example of the feature amount selection processing of the feature amount selection device 10 according to the present embodiment.

Step S10: The feature amount data acquisition unit 100 acquires the feature amount data D supplied by the feature amount data supply unit 20. The feature amount data acquisition unit 100 supplies the acquired feature amount data D to the preprocessing unit 101.

Step S20: The preprocessing unit 101 performs preprocessing on the feature amount data D supplied from the feature amount data acquisition unit 100. Here, in a case where the number of samples corresponding to a feature amount included in the feature amount data D is missing by a predetermined ratio or more, the preprocessing unit 101 removes the feature amount from the feature amount data D. In a case where the number of feature amounts corresponding to a sample included in the feature amount data D is missing by a predetermined ratio or more, the preprocessing unit 101 removes the sample from the feature amount data D. The preprocessing unit 101 reduces the dimension of feature amounts included in the feature amount data D on the basis of a feature amount reduction method in accordance with a field to which the feature amount selection system 1 is applied.

The preprocessing unit 101 supplies the feature amount data D having been subjected to the preprocessing to the numerical featurization normalization unit 102.

Step S30: The numerical featurization normalization unit 102 performs processing of numerical featurization and normalization on the feature amount data D having been subjected to the preprocessing. Here, in the numerical featurization processing, the numerical featurization normalization unit 102 converts a categorical feature amount into a numerical feature amount for the feature amount data D having been subjected to the preprocessing. The numerical featurization normalization unit 102 uses, for example, one-hot encoding or label encoding for processing of converting a categorical feature amount into a numerical feature amount. The numerical featurization normalization unit 102 performs normalization processing on the feature amount data D.

The numerical featurization normalization unit 102 supplies the feature amount data D having been subjected to processing of numerical featurization and normalization to the principal component analysis unit 103.

Step S40: The principal component analysis unit 103 performs principal component analysis in the sample space on the feature amount data D supplied from the numerical featurization normalization unit 102. The numerical featurization normalization unit 102 generates the sample space principal component P as a result of the principal component analysis. The principal component analysis unit 103 supplies the generated sample space principal component P to the distortion determination unit 104 and the feature amount selection unit 105.

Step S50: The distortion determination unit 104 determines whether there is distortion in the distribution of the sample space principal component P for the sample space principal component P supplied from the principal component analysis unit 103. The distortion determination unit 104 performs the determination on the principal components included in the sample space principal component P in order from the first principal component.

In the present embodiment, the distortion of the distribution of the sample space principal component P is, for example, a deviation of the distribution from a normal distribution. The distortion determination unit 104 performs determination on the basis of skewness as an example. The deviation of the distribution of the sample space principal component P from the normal distribution is determined. When the skewness of the distribution of the sample space principal component P deviates from 0 by a predetermined value, the distortion determination unit 104 determines that there is distortion in the distribution.

The distortion determination unit 104 may perform determination on the basis of kurtosis instead of skewness. The distortion determination unit 104 may perform determination on the basis of an arithmetic mean or a standard deviation. The distortion determination unit 104 may perform determination on the basis of a combination of any one or more of the arithmetic mean, the standard deviation, the skewness, or the kurtosis.

Note that in the present embodiment, an example of a case where the distortion determination unit 104 determines distortion of the distribution of the sample space principal component P as a deviation of the distribution from the normal distribution has been described. However, the present invention is not limited to this. The distortion determination unit 104 may perform determination on the basis of the similarity between the distribution of the sample space principal component P and an asymmetric distribution. In this case, when the distribution of the sample space principal component P and the asymmetric distribution are not similar, the distortion determination unit 104 determines that there is no distortion in the distribution of the sample space principal component P. The asymmetric distribution is, for example, a distribution that is not line-symmetric with respect to a center value.

The distortion determination unit 104 supplies a determination result of the distortion in the distribution of the sample space principal component P to the feature amount selection unit 105. Here, in FIG. 4, it is assumed that it is determined that there is distortion from the first principal component to the N-th principal component in the sample space principal component P, as an example. That is, it is assumed that it is determined that there is no distortion in the principal components in and after the (N+1)-th principal component in the sample space principal component P.

Step S60: The feature amount selection unit 105 selects a feature amount from among a plurality of feature amounts included in the feature amount data D on the basis of the sample space principal component P supplied from the principal component analysis unit 103 and the determination result supplied from the distortion determination unit 104. Here, the feature amount selection unit 105 selects a feature amount having a large distance from the origin of the sample space for the sample space principal component P determined to have no distortion in the distribution of the sample space principal component P.

Here, using K components from the (N+1)-th principal component to the (N+K)-th principal component determined to have no distortion in distribution, the feature amount selection unit 105 selects a feature amount having a large distance from the origin of the sample space. In other words, the feature amount selection unit 105 selects a feature amount whose distance from the origin is larger than a predetermined distance in a K-dimensional partial space corresponding to principal components from the (N+1)-th principal component to the (N+K)-th principal component in the sample space. Here, the feature amount selection unit 105 selects M feature amounts in descending order of distance from the origin of the sample space.

K is an integer of 0 or more. M is an integer of 1 or more. The values of K and M are supplied from the feature amount data supply unit 20 to the feature amount selection device 10 together with the feature amount data D. As the values of K and M, values designated by the user, for example, are supplied from the feature amount data supply unit 20. Note that the feature amount selection unit 105 may use, as the values of K and M, for example, a predetermined value based on a cluster structure or the like assumed for the feature amount in accordance with a field to which the feature amount selection system 1 is applied.

Note that the distance from the origin of a feature amount is, for example, a Euclidean distance. Note that a distance other than the Euclidean distance may be used as the distance from the origin of the feature amount.

Note that the feature amount selection unit 105 may select a feature amount whose distance from the origin of the sample space is larger than a predetermined distance without providing an upper limit on the number of feature amounts to be selected in advance.

Here, a feature amount having a small distance from the origin in the sample space is considered to be a feature amount that does not contribute to cluster separation of the sample and corresponds to noise. The distribution of the feature amount tends to follow a normal distribution. By selecting a feature amount having a large distance from the origin on the basis of the sample space principal component P, the feature amount selection device 10 removes a feature amount corresponding to noise from the feature amount data D.

Step S70: The feature amount selection unit 105 outputs, to the output unit 106, the feature amount selection result R indicating the selected M feature amounts.

Thus, the feature amount selection device 10 ends the feature amount selection processing.

As described above, the feature amount selection unit 105 selects a feature amount from among the plurality of feature amounts on the basis of some of the principal components of the sample space principal component P obtained by the principal component analysis in the sample space. Note that in the present embodiment, an example of a case where the feature amount selection unit 105 selects a feature amount on the basis of a principal component determined to have no distortion in distribution from among the sample space principal component P has been described. However, the present invention is not limited to this. For example, the feature amount selection unit 105 may remove a predetermined number of principal components from the first principal component from among the sample space principal component P. That is, in the present embodiment, the above-described number N is determined on the basis of the distortion of the distribution in the sample space principal component P, but a number determined in advance may be used as the number N.

Hereinafter, examples in which the feature amount selection system 1 according to the present embodiment is applied will be described.

### First Example

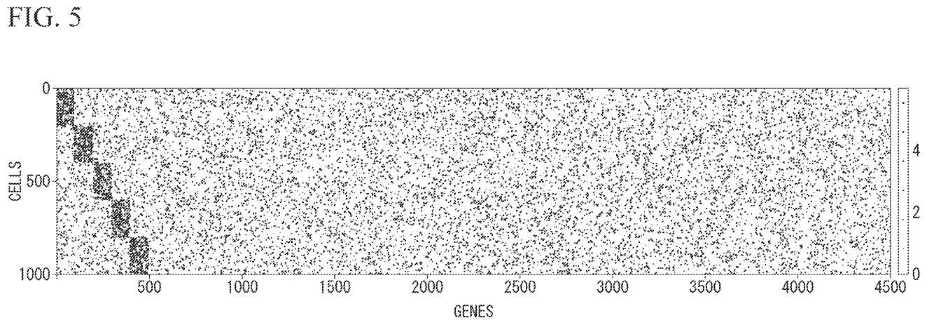

In the first example, artificial data D1, which is artificially generated data, is used as the feature amount data D. FIG. 5 is a view illustrating an example of the artificial data D1 according to the present example. The artificial data D1 stores values of 4500 feature amounts for each of 1000 samples. In the artificial data D1, density is given to the distribution of feature amounts on an assumption of five cluster structures. As illustrated in FIG. 5, the dense portion is given as five rectangles in the range of the first to about 500th feature amounts. A portion other than the dense portion, that is, a portion other than the five rectangles, is provided as background noise.

Before describing an analysis result by the feature amount selection system 1 of the present example, a comparative example with respect to the analysis result will be described. FIG. 6 is a view illustrating an example of a result of cluster analysis of a comparison target according to the present example. FIG. 6 illustrates a result of dimension reduction in a feature amount space in a case where the feature amount is selected by a known feature amount selection technique. In the known feature amount selection, only processing corresponding to the above-described preprocessing (processing in step S20 illustrated in FIG. 4) is performed. In the comparative example, feature amount selection by preprocessing is performed, and 1000 feature amounts are selected from the 4500 feature amounts included in the artificial data D1. FIG. 6 illustrates a result of cluster analysis performed on data of the 1000 feature amounts selected by the preprocessing. In the cluster analysis, markers corresponding to respective samples are displayed on a two-dimensional plane obtained by unsupervised dimension reduction, and visualization is performed. The markers form a cluster for each class, and the features of the samples are captured on the two-dimensional plane.

Hereinafter, details of the feature amount selection processing by the feature amount selection system 1 of the present example will be described in association with the processing of FIG. 4 described above.

In the preprocessing in step S20, a method (see Non-Patent Document 2, for example) used for analysis of gene expression data and the like is applied. The preprocessing unit 101 reduces the 4500 feature amounts included in the artificial data D1 to 1000 feature amounts by preprocessing.

In the processing of numerical featurization and normalization in step S30, all the feature amounts included in the artificial data D1 of the present example are numerical feature amounts, and therefore the numerical featurization is not necessary. Through the normalization processing, the numerical featurization normalization unit 102 converts the values of the feature amounts, and thus the average value becomes 0 and the standard deviation becomes 1 for the values of the feature amounts.

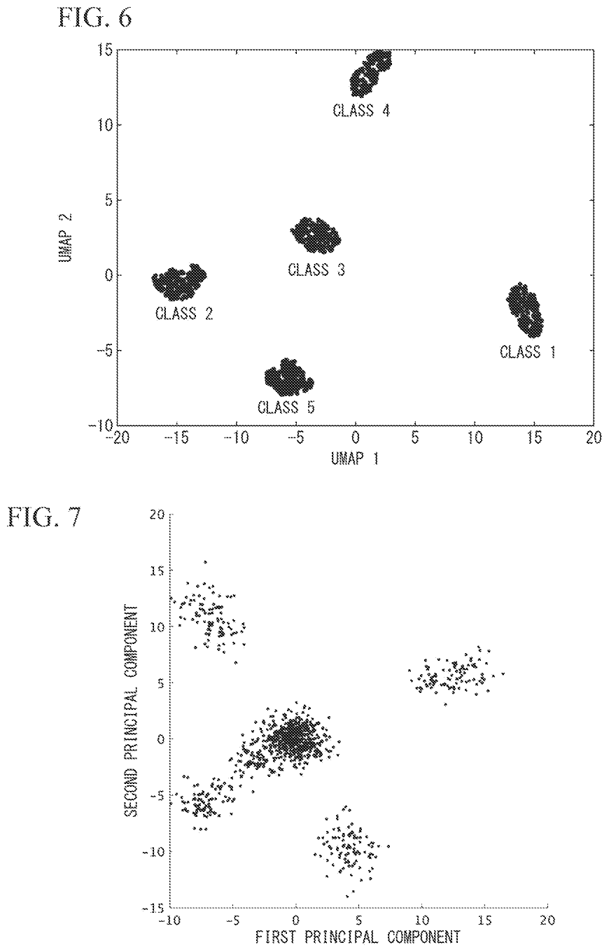

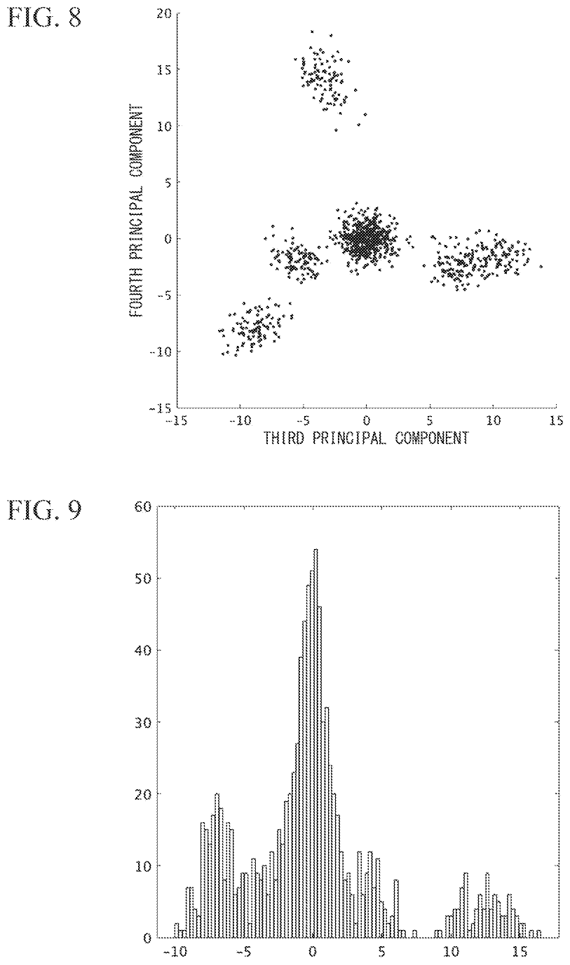

The results of the sample space principal component P obtained by the principal component analysis in the sample space in step S40 are illustrated in FIGS. 7 and 8. FIG. 7 illustrates the first principal component and the second principal component in the sample space. FIG. 8 illustrates the third principal component and the fourth principal component in the sample space. In FIGS. 7 and 8, each point corresponds to a respective feature amount.

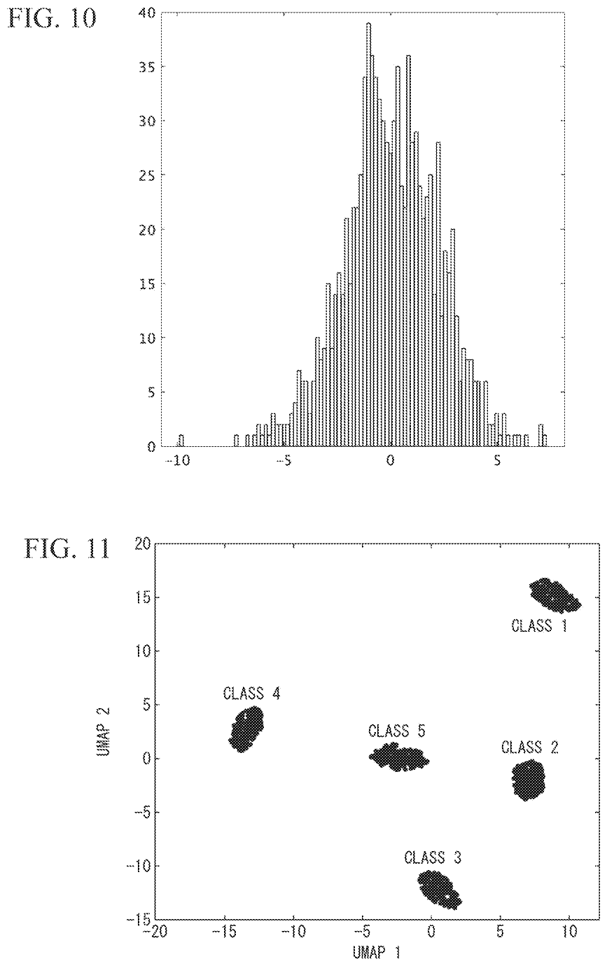

In determination of distortion of the distribution of the principal component in step S50, the distortion determination unit 104 determines a distribution deviating from the normal distribution among the sample space principal component P. The distribution of each of the first principal component and the sixth principal component among the sample space principal components P, which are the principal components in the sample space, are illustrated in FIGS. 9 and 10, respectively. FIG. 9 indicates that the distribution of the first principal component has a large deviation from the normal distribution, and has a distortion in the distribution. The distribution from the second principal component to the fifth component that are not illustrated also has a distortion. FIG. 10 indicates that the distribution of the sixth principal component is close to the normal distribution, and has no distortion in the distribution. The distribution of the seventh component and the subsequent components that are not illustrated also has no distortion. Among the sample space principal component P, a principal component having a distribution with a large deviation from the normal distribution is not used in selection of the feature amount and is excluded. In the present example, the first to the fifth principal components are excluded.

In the selection of the feature amount in step S60, the feature amount selection unit 105 selects 200 feature amounts in descending order of the Euclidean distance from the origin of the sample space using the sixth and subsequent principal components except the first to fifth principal component among the sample space principal component P. As described above, the number of feature amounts to be selected is determined in advance as a parameter.

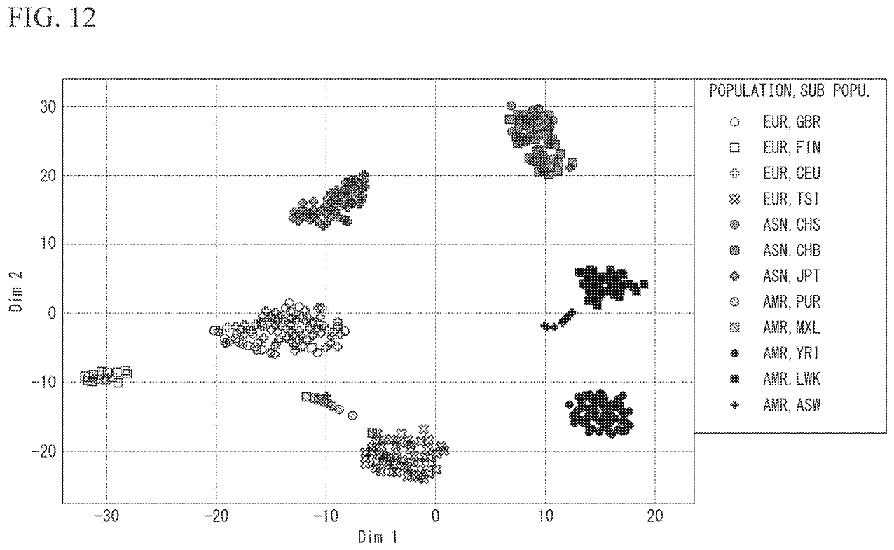

FIG. 11 illustrates a result of performing preprocessing (that is, dimension reduction processing) similar to obtaining the plot of FIG. 6, using the 200 feature amounts selected by the feature amount selection processing described above. FIG. 11 is a view illustrating a result of dimension reduction in the feature amount space. It is found that a substantially similar cluster structure is obtained, through comparison between the result (FIG. 11) obtained by using the 200 feature amounts selected by the feature amount selection processing by the feature amount selection system 1 and the result (FIG. 6) obtained by using the 1000 feature amounts selected by the known feature amount selection technique. That is, it is found that the feature amount selection processing by the feature amount selection system 1 has successfully reproduced the result by the known feature amount selection technique while significantly reducing the (number of) dimensions of the feature amounts.

According to the result of the present example, since the feature amount selection system 1 can reduce the (number of) dimensions of the feature amount while maintaining the cluster structure as compared with the result by the known feature amount selection technique, the feature amount selection system 1 can speed up the calculation without impairing the analysis accuracy.

### Second Example

The second example uses, as the feature amount data D, genotype data D2 based on a whole genome sequence disclosed in Non-Patent Document 3. The genotype data D2 stores values of 20 million feature amounts for each of 600 samples.

The genotype data is data representing a difference of a base at each locus from a reference genome. The genotype data is used in a study for classifying samples (as an example, human) into a disease group and a non-disease group and finding genetic mutations that appear specifically in the disease group. The genotype data D2 used in the present example is not data for two groups related to disease, and in the present example, analysis focusing on the genetic derivation of an ancestor for the result of unsupervised dimension reduction is performed.

FIG. 12 illustrates a result of cluster analysis in which the feature amount selection described in Patent Document 4, which is a known technique, is not performed, as a comparison target with respect to the present example. FIG. 12 is a view illustrating an example of a result of cluster analysis of a comparison target according to the present example. FIG. 12 illustrates a result in which the 20 million feature amounts are reduced to one hundred thousand feature amounts by preprocessing for the genotype data D2, and then unsupervised dimension reduction is performed two-dimensionally on the feature amount space for the one hundred thousand feature amounts.

Each marker indicates a population such as European and a subpopulation included in each population. The markers form a cluster for each population, and the features of the samples are captured on a two-dimensional plane by dimension reduction. In the dimension reduction, since the one hundred thousand feature amounts obtained by performing the preprocessing on the genotype data D2 are used as they are, a considerable calculation time is required.

Hereinafter, details of the feature amount selection processing by the feature amount selection system 1 of the present example will be described in association with the processing of FIG. 4 described above.

In the preprocessing of step S20, the preprocessing unit 101 performs preprocessing on the 20 million feature amounts included in the genotype data D2. Here, the preprocessing unit 101 removes a feature amount having a defect in 20% or more of the samples. The preprocessing unit 101 removes a sample having a defect in 20% or more of the feature amounts. The preprocessing unit 101 removes a feature amount having a defect in 2% or more of the samples. The preprocessing unit 101 removes a sample having a defect in 2% or more of the feature amounts. The preprocessing unit 101 removes a feature amount having a minor allele frequency of 5% or less.

In the processing of numerical featurization and normalization in step S30, since all the feature amounts included in the genotype data D2 are categorical feature amounts called genotypes, the numerical featurization normalization unit 102 converts the categorical feature amounts into numerical feature amounts using label encoding. Note that in the present example, normalization of the value of the feature amount is not performed.

The result of the cluster analysis illustrated in FIG. 12 is the same as the result in a case where the preprocessing in step S20 and the processing of numerical featurization and normalization in step S30 are performed on the genotype data D2, and the dimension reduction is performed in the feature amount space.

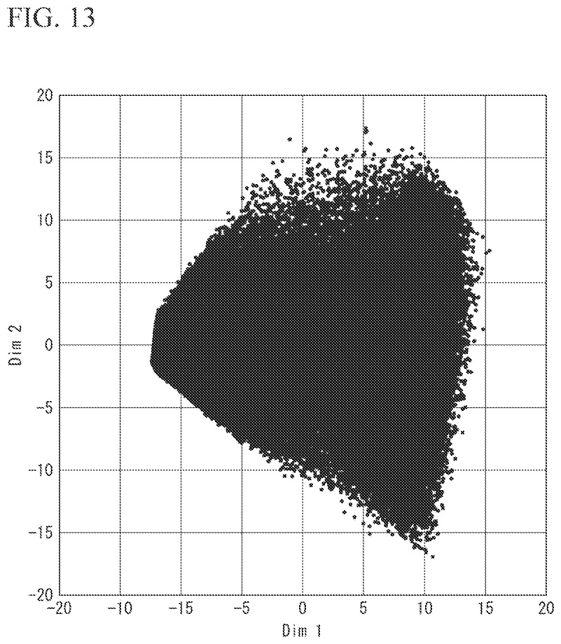

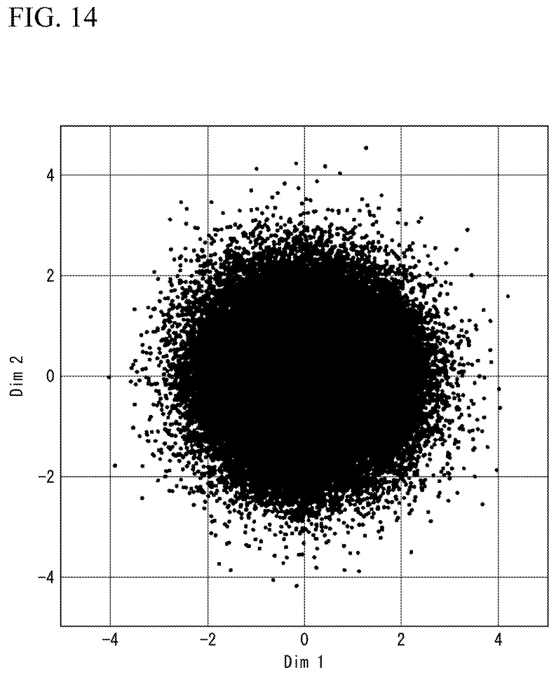

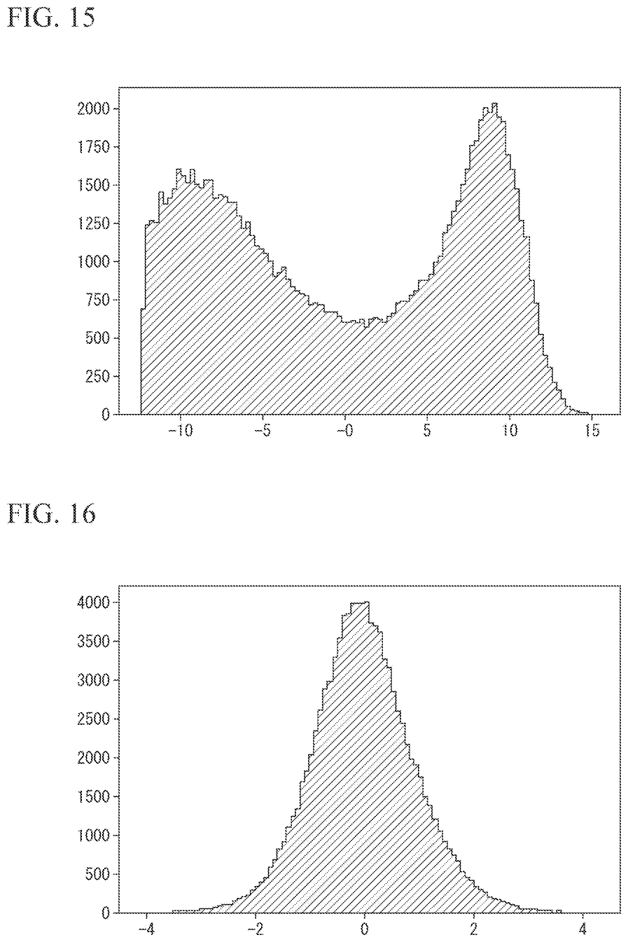

The results of the sample space principal component P obtained by the principal component analysis in the sample space in step S40 are illustrated in FIGS. 13 and 14. FIG. 13 illustrates the first principal component and the second principal component in the sample space. FIG. 14 illustrates the third principal component and the fourth principal component in the sample space. In FIGS. 13 and 14, each point corresponds to a respective feature amount. In FIG. 13, the density of each point is high in the range where the value of the first principal component is around −10 and the range where the value of the first principal component is around +10. The fact that the density of each point is high in the range in FIG. 13 can also be confirmed from the distribution illustrated in FIG. 15 described later. Furthermore, the fact that the density of each point is high in the vicinity where the value of the first principal component is 0 and the value of the second principal component is 0 in FIG. 14 can also be confirmed from the distribution illustrated in FIG. 16 described later.

In determination of distortion of the distribution of the principal component in step S50, the distortion determination unit 104 determines a distribution deviating from the normal distribution among the sample space principal component P. The distribution of each of the first principal component and the fourth principal component among the sample space principal components P, which are the principal components in the sample space, are illustrated in FIGS. 15 and 16, respectively. FIG. 15 indicates that the distribution of the first principal component has a large deviation from the normal distribution, and has a distortion in the distribution. The distribution from the second principal component to the third component that are not illustrated also has a distortion. FIG. 16 indicates that the distribution of the fourth principal component is close to the normal distribution, and has no distortion in the distribution. The distribution of the fifth component and the subsequent components that are not illustrated also has no distortion. Among the sample space principal component P, a principal component having a distribution with a large deviation from the normal distribution is not used in selection of the feature amount and is excluded. In the present example, the first to third principal components are excluded.

In the selection of the feature amount in step S60, the feature amount selection unit 105 selects 1000 feature amounts in descending order of the Euclidean distance from the origin of the sample space using the fourth and subsequent principal components except the first to third principal component among the sample space principal component P. As described above, the number of feature amounts to be selected is determined in advance as a parameter.

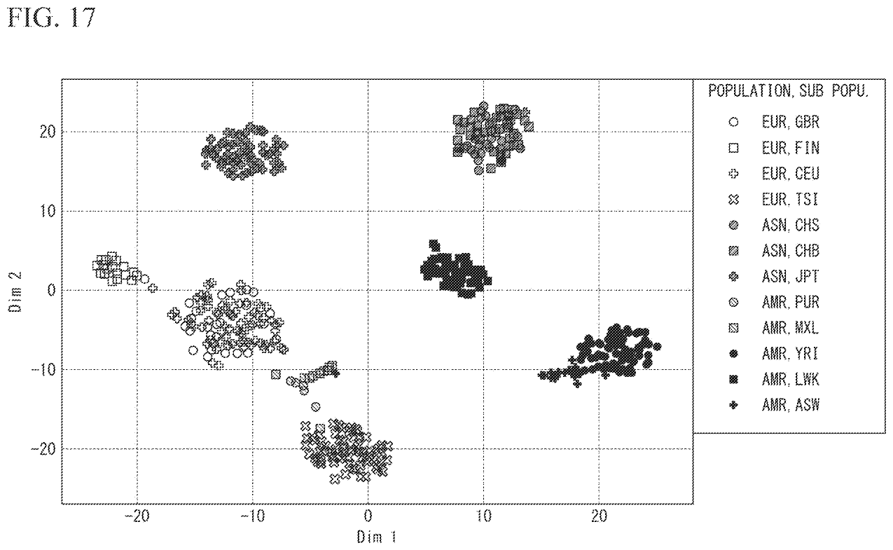

FIG. 17 illustrates a result of performing preprocessing (that is, dimension reduction processing) similar to obtaining the plot of FIG. 12, using the 1000 feature amounts selected by the feature amount selection processing described above. FIG. 17 is a view illustrating a result of dimension reduction in the feature amount space. It is found that a substantially similar cluster structure is obtained, through comparison between the result (FIG. 17) obtained by using the 1000 (corresponding to 1% of the original one hundred thousand feature amounts included in the genotype data D2) feature amounts selected by the feature amount selection processing by the feature amount selection system 1 and the result (FIG. 12) obtained by using the one hundred thousand feature amounts selected by the known feature amount selection technique. That is, it is found that the feature amount selection processing by the feature amount selection system 1 has successfully reproduced the result by the known feature amount selection technique while significantly reducing the (number of) dimensions of the feature amounts.

According to the result of the present example, since the feature amount selection system 1 can reduce the (number of) dimensions of the feature amount while maintaining the cluster structure as compared with the result by the known feature amount selection technique, the feature amount selection system 1 can speed up the calculation without impairing the analysis accuracy.

### Third Example

The third example uses, as the feature amount data D, human gene expression data D3 disclosed in Non-Patent Document 5. The gene expression data D3 stores values of 6713 feature amounts for each of 3694 samples.

The gene expression data is data in which each feature amount is an expression amount of a specific (single) gene. In the gene expression data, a sample corresponds to a cell. In the gene expression data, the sample group is classified into an abnormal cell group and a normal cell group, and is used in a study for finding a gene having a high or low expression level specific to the abnormal cell group.

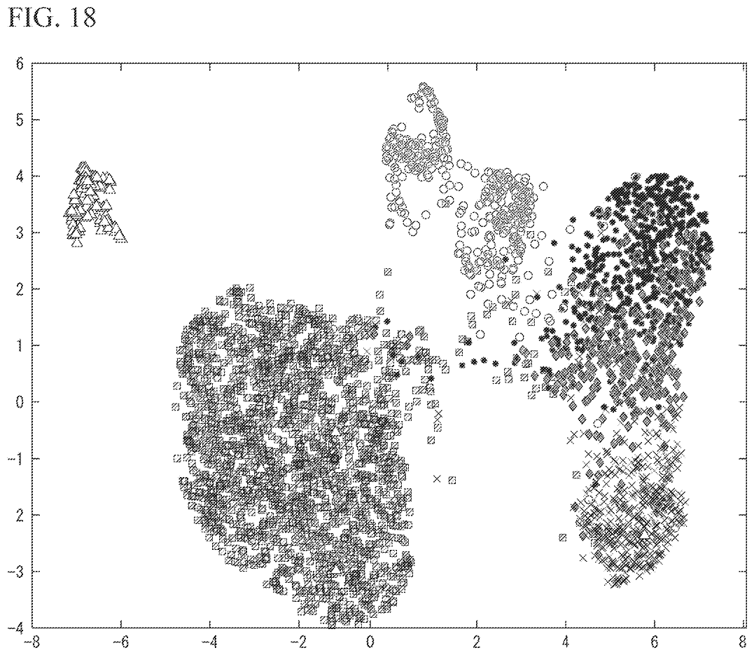

FIG. 18 illustrates a result of cluster analysis in which the feature amount selection described in Patent Document 6, which is a known technique, is not performed, as a comparison target with respect to the present example. FIG. 18 is a view illustrating an example of a result of cluster analysis of a comparison target according to the present example. FIG. 18 illustrates a result in which the 6713 feature amounts are reduced to 2000 feature amounts by preprocessing for the gene expression data D3, and then unsupervised dimension reduction is performed two-dimensionally on the feature amount space for the 2000 feature amounts.

Each marker indicates the type of cell. The markers form a cluster for each cell type, and the features of the samples are captured on a two-dimensional plane by dimension reduction.

Hereinafter, details of the feature amount selection processing by the feature amount selection system 1 of the present example will be described in association with the processing of FIG. 4 described above.

In the preprocessing of step S20, the preprocessing unit 101 performs preprocessing on the 6713 feature amounts included in the gene expression data D3. In the preprocessing in step S20, a method (see Non-Patent Document 2, for example) used for analysis of gene expression data and the like is applied. The preprocessing unit 101 reduces the 6713 feature amounts included in the gene expression data D3 to 2000 feature amounts by preprocessing.

In the processing of numerical featurization and normalization in step S30, all the feature amounts included in the gene expression data D3 of the present example are numerical feature amounts, and therefore the numerical featurization is not necessary. Through the normalization processing, the numerical featurization normalization unit 102 converts the values of the feature amounts, and thus the average value becomes 0 and the standard deviation becomes 1 for the values of the feature amounts.

The result of the cluster analysis illustrated in FIG. 18 is the same as the result in a case where the preprocessing in step S20 and the processing of numerical featurization and normalization in step S30 are performed on the gene expression data D3, and the dimension reduction is performed in the feature amount space.

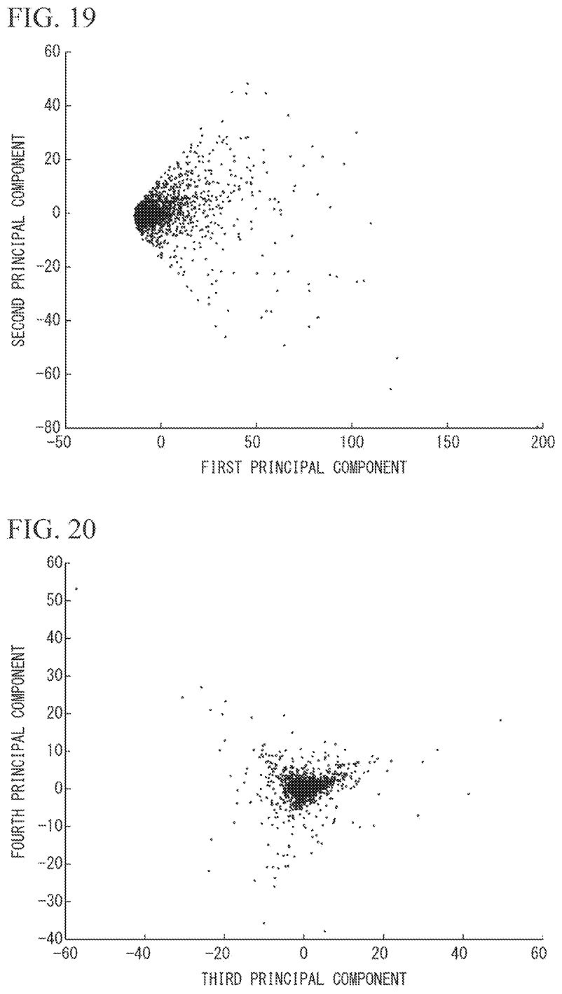

The results of the sample space principal component P obtained by the principal component analysis in the sample space in step S40 are illustrated in FIGS. 19 and 20. FIG. 19 illustrates the first principal component and the second principal component in the sample space. FIG. 20 illustrates the third principal component and the fourth principal component in the sample space. In FIGS. 13 and 14, each point corresponds to a respective feature amount.

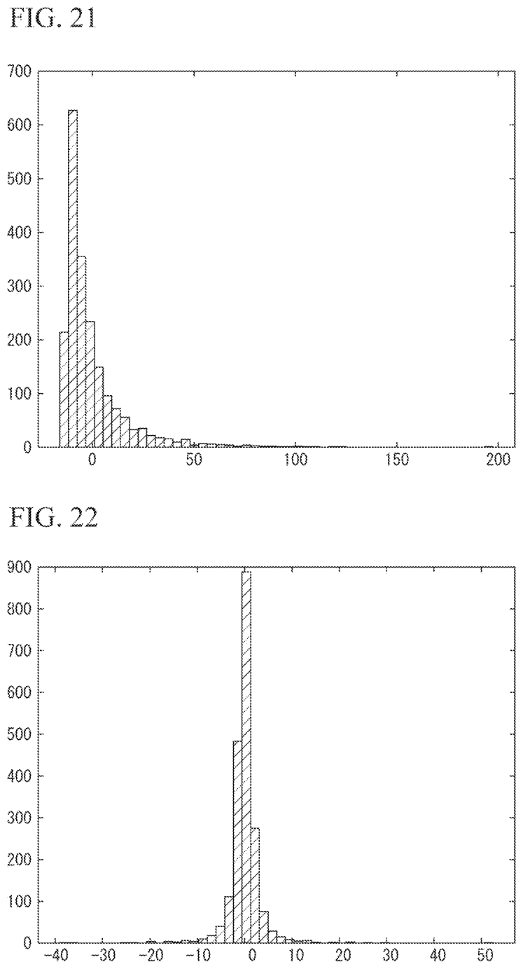

In determination of distortion of the distribution of the principal component in step S50, the distortion determination unit 104 determines a distribution deviating from the normal distribution among the sample space principal component P. The distribution of each of the first principal component and the fifth principal component among the sample space principal components P, which are the principal components in the sample space, are illustrated in FIGS. 21 and 22, respectively. FIG. 21 indicates that the distribution of the first principal component has a large deviation from the normal distribution, and has a distortion in the distribution. The distribution from the second principal component to the third component that are not illustrated also has a distortion. FIG. 22 indicates that the distribution of the fifth principal component is close to the normal distribution, and there is no distortion thereto. The distribution of the fourth component, the sixth component, and the subsequent components that are not illustrated are also not distorted. Among the sample space principal component P, a principal component having a distribution with a large deviation from the normal distribution is not used in selection of the feature amount and is excluded. In the present example, the first to third principal components are excluded, and the fourth to tenth principal component are used for subsequent processing.

In the selection of the feature amount in step S60, the feature amount selection unit 105 selects 300 feature amounts in descending order of the Euclidean distance from the origin of the sample space using the fourth to tenth principal components except the first to third principal components among the sample space principal component P. As described above, the number of feature amounts to be selected is determined in advance as a parameter.

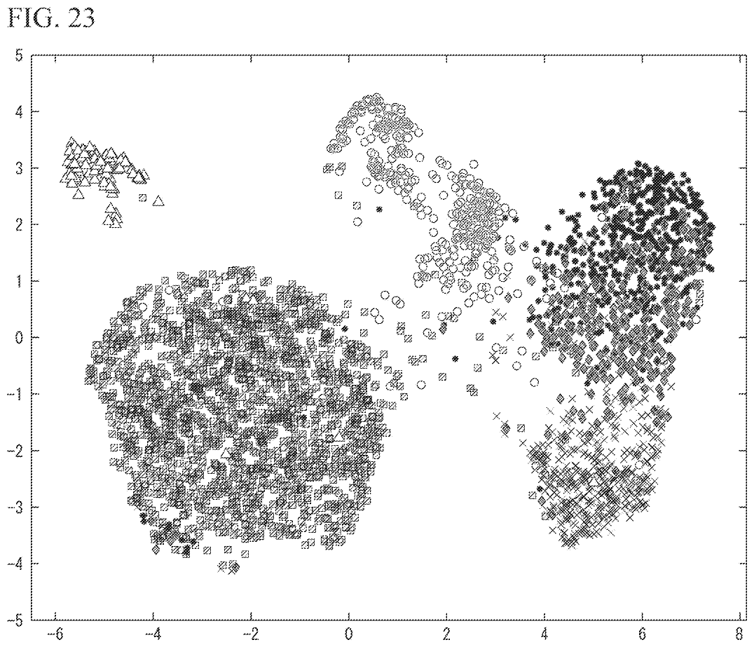

FIG. 23 illustrates a result of performing preprocessing (that is, dimension reduction processing) similar to obtaining the plot of FIG. 18, using the 300 feature amounts selected by the feature amount selection processing described above. FIG. 23 is a view illustrating a result of dimension reduction in the feature amount space. It is found that a substantially similar cluster structure is obtained, through comparison between the result (FIG. 23) obtained by using the 300 feature amounts selected by the feature amount selection processing by the feature amount selection system 1 and the result (FIG. 18) obtained by using the 2000 feature amounts selected by the known feature amount selection technique. That is, it is found that the feature amount selection processing by the feature amount selection system 1 has successfully reproduced the result by the known feature amount selection technique while significantly reducing the (number of) dimensions of the feature amounts. In a case where 300 feature amounts are directly selected by a known feature amount selection technique, a cluster structure cannot be obtained (not illustrated), thereby indicating that the feature amount selection system 1 can save the cluster structure even with a smaller feature amount.

According to the result of the present example, since the feature amount selection system 1 can reduce the (number of) dimensions of the feature amount while maintaining the cluster structure as compared with the result by the known feature amount selection technique, the feature amount selection system 1 can speed up the calculation without impairing the analysis accuracy.

### Supplement

As described above, the feature amount selection device 10 according to the present embodiment includes the feature amount data acquisition unit 100, the principal component analysis unit 103, and the feature amount selection unit 105.

The feature amount data acquisition unit 100 acquires feature amount data D including a set of values of a plurality of feature amounts for a sample, for each of a plurality of the samples. The principal component analysis unit 103 performs, on the feature amount data D, principal component analysis in a sample space that is a collection of the plurality of feature amounts of a set of values for each of the plurality of the samples of the feature amounts. The feature amount selection unit 105 selects a feature amount from among a plurality of feature amounts on the basis of a result of the principal component analysis performed by the principal component analysis unit 103.

This configuration enables the feature amount selection device 10 according to the present embodiment to select a main feature amount by removing a feature amount that becomes noise, and therefore it is possible to speed up calculation without impairing analysis accuracy in analysis of high-dimensional feature amount data. Here, speeding up means being able to shorten the calculation time as compared with that of before reducing the (number of) dimensions of the feature amount.

Analysis of high-dimensional feature amount data has a problem in that accuracy of machine learning is deteriorated due to a large number of explanatory variables. The analysis of high-dimensional feature amount data also has a problem of taking an enormous amount of time for analysis calculation because the calculation amount is large. In the high-dimensional feature amount data, difficulty arises in interpretability and explainability with respect to the analysis result of cluster analysis or regression analysis.

Since the feature amount selection device 10 according to the present embodiment enables analysis using only a small number of main feature amounts, it is possible to shorten the time required for analysis. Since the feature amount that becomes noise can be removed from the analysis, improvement of the analysis accuracy or the obtainment of findings not previously obtained is expected. Since the analysis result can be evaluated on the basis of a small feature amount, interpretability and explainability of the analysis are improved.

Use of the feature amount selection device 10 according to the present embodiment enables narrowing down feature amounts that work dominantly in a specific sample group. The feature amount selection device 10 is suitably used for specifying a marker gene exhibiting a specific function from among a large number of genes, for example.

The feature amount selection device 10 according to the present embodiment further includes the distortion determination unit 104. The distortion determination unit 104 determines whether there is distortion in a distribution of a principal component (in the present embodiment, the sample space principal component P) obtained by the principal component analysis in the sample space. The feature amount selection unit 105 selects a feature amount from among a plurality of feature amounts on the basis of a principal component determined to have no distortion in distribution (in the present embodiment, distribution of the sample space principal component P) in a principal component (in the present embodiment, the sample space principal component P) obtained by principal component analysis.

This configuration enables the feature amount selection device 10 according to the present embodiment to elicit the feature (close to the normal distribution) of the distribution of feature amounts contributing to the noise from among the plurality of feature amounts in a principal component determined to have no distortion in distribution, as compared with a case of selecting a principal component without distinguishing the presence or absence of distortion in the distribution, and therefore it is possible to select the feature amount without deteriorating the analysis accuracy, as compared with the case of selecting the principal component without distinguishing between the presence or absence of distortion in the distribution.

In the feature amount selection device 10 according to the present embodiment, the feature amount selection unit 105 selects a feature amount having a large distance from the origin of the sample space for a principal component determined to have no distortion in distribution (in the present embodiment, distribution of the sample space principal component P).

This configuration enables the feature amount selection device 10 according to the present embodiment to exclude a feature amount contributing to noise on the basis of the distance from the origin of the sample space for a principal component determined to have no distortion in distribution, and therefore it is possible to select the feature amount without deteriorating the analysis accuracy as compared with a case of not performing selection on the basis of the distance.

Note that a part of the feature amount selection device 10 in the above-described embodiment, for example, the feature amount selection device 10, the preprocessing unit 101, the numerical featurization normalization unit 102, the principal component analysis unit 103, the distortion determination unit 104, the feature amount selection unit 105, and the output unit 106 may be implemented by a computer. In that case, this configuration may be implemented by recording a program for achieving such a control function in a computer-readable recording medium and causing a computer system to read and execute the program recorded in the recording medium. Note that the “computer system” mentioned here is a computer system incorporated in the feature amount selection device 10, and includes hardware such as an OS and peripheral devices. In addition, the “computer-readable recording medium” refers to a portable medium such as a flexible disk, a magneto-optical disk, a ROM, or a CD-ROM, and a storage device such as a hard disk incorporated in a computer system. In addition, the “computer-readable recording medium” may include a recording medium that dynamically stores a program for a short period of time, such as a communication wire when the program is transmitted via a network such as the Internet or a communication line such as a telephone line, and a recording medium that stores a program for a fixed period of time, such as volatile memory inside a computer system that serves as a server or a client in the above-mentioned case. Further, the above-described program may be a program for achieving some of the above-described functions, or may be a program that can achieve the above-described functions in combination with a program that is already recorded in the computer system.

A part or entirely of the feature amount selection device 10 in the above-described embodiment may be implemented as an integrated circuit such as a large-scale integration (LSI). Each functional block of the feature amount selection device 10 may be provided as a respective individual processor, or a part or entirely of the functional blocks may be integrated into a processor. In addition, a circuit integration method is not limited to LSI and may be implemented by a dedicated circuit or a general-purpose processor. In addition, when an integrated circuit technology that replaces LSI emerges with the progress of semiconductor technologies, an integrated circuit based on the technology may be used.

Although one embodiment of the present invention has been described above in detail with reference to the drawings, specific configurations are not limited to those described above, and various changes in design or the like may be made within the scope that does not depart from the gist of the invention.

### REFERENCE SIGNS LIST

. . . Feature amount selection device
100 . . . Feature amount data acquisition unit
103 . . . Principal component analysis unit
105 . . . Feature amount selection unit
D . . . Feature amount data

1. A feature amount selection device comprising:
a feature amount data acquisition unit that acquires feature amount data including a set of values of a plurality of feature amounts for a sample, for each of a plurality of the samples;
a principal component analysis unit that performs, on the feature amount data, principal component analysis in a sample space that is a collection of the plurality of feature amounts of a set of values for each of the plurality of the samples of the feature amounts;
a distortion determination unit that determines whether there is distortion in a distribution of a principal component obtained by the principal component analysis in the sample space; and
a feature amount selection unit that selects a feature amount from among the plurality of the feature amounts based on a principal component determined to have no distortion in the distribution among the principal components obtained by the principal component analysis performed by the principal component analysis.

2. (canceled)

3. The feature amount selection device according to claim 21,
wherein the feature amount selection unit selects a feature amount having a large distance from an origin of the sample space for a principal component determined to have no distortion in the distribution.

4. A feature amount selection method comprising:
feature amount data acquisition of acquiring feature amount data including a set of values of a plurality of feature amounts for a sample, for each of a plurality of the samples;
principal component analysis of performing, on the feature amount data, principal component analysis in a sample space that is a collection of the plurality of feature amounts of a set of values for each of the plurality of the samples of the feature amounts;
a distortion determination of determining whether there is distortion in a distribution of a principal component obtained by the principal component analysis in the sample space; and
feature amount selection of selecting a feature amount from among the plurality of the feature amounts based on a principal component determined to have no distortion in the distribution among the principal components obtained by the principal component analysis performed in the principal component analysis.

5. A program for causing a computer to execute
feature amount data acquisition of acquiring feature amount data including a set of values of a plurality of feature amounts for a sample, for each of a plurality of the samples,
principal component analysis of performing, on the feature amount data, principal component analysis in a sample space that is a collection of the plurality of feature amounts of a set of values for each of the plurality of the samples of the feature amounts,
a distortion determination of determining whether there is distortion in a distribution of a principal component obtained by the principal component analysis in the sample space, and
feature amount selection of selecting a feature amount from among the plurality of the feature amounts based on a principal component determined to have no distortion in the distribution among the principal components obtained by the principal component analysis performed in the principal component analysis.
